(19) United States
(12) Patent Application Publication
(10) Pub. No.: US 2009/0225951 A1
(43) Pub. Date: Sep. 10, 2009

(54) Composite frame for x-ray tubes

(75) Inventors: Norman E. Wandke, Naperville, IL (US); Mark S. Maska, Palatine, IL (US)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC, N.V., EINDHOVEN (NL)

(21) Appl. No.: 10/596,957

(22) PCT Filed: Jan. 5, 2005
(86) PCT No.: PCT/IB05/50040

§ 371 Date: Jun. 30, 2006

Related U.S. Application Data
(60) Provisional application No. 60/536,077, filed on Jan. 13, 2004.

(51) Int. Cl. H01J 35/12

(52) U.S. Cl. 378/141

(57) ABSTRACT

An x-ray tube assembly (10) includes a frame (16) which defines an evacuated chamber (14). A central portion (40) of the frame which houses an anode (12) is formed from a thermally conductive liner (64) and a structural framework (62). The liner conducts heat away from the evacuated chamber to a surrounding cooling fluid. The framework provides windows (80, 80′, 80″, 82, 82′, 124), through which the liner is in direct thermal contact with both the cooling fluid and the evacuated chamber.

The present application relates to the x-ray tube arts. The invention finds particular application in connection with a composite frame for an x-ray tube which facilitates heat removal while retaining high strength and rigidity and will be described with particular reference thereto. It will be appreciated, however, that the invention finds application in a variety of applications where it is desirable to transfer heat efficiently.

X-ray tubes include an evacuated envelope or frame which houses a cathode assembly and an anode assembly. A high potential, on the order of 100-200 kV, is applied between the cathode assembly and the anode assembly. Electrons emitted by the cathode assembly strike a target region of the anode with sufficient energy that x-rays are generated. However, not all the energy is converted to x-rays. Rather, a substantial portion of the energy is converted to heat, resulting in localized heating of the target and subsequently the envelope. In order to distribute the thermal loading created during the production of x-rays, a constant flow of a cooling liquid, such as a dielectric oil, is maintained around the frame throughout x-ray generation.

Conventionally, x-ray tube envelopes were formed of glass. Glass is easy to shape, inexpensive, and transmits thermal radiation. However, it has several drawbacks. It is subject to cracking due to surface defects. Because glass is a brittle material, these failures are often rapid and unpredictable. Cracking also tends to occur when the glass is subjected to a thermal gradient that is exacerbated if the glass is too thick. Glass is also subject to high voltage puncture and loss of insulating properties due to evaporated metal collecting on the surface. Particularly in computed tomography (CT) scanners, the increased gantry speeds generate forces on the frame which glass envelopes are unable to withstand.

Metals such as copper, stainless steels, and nickel iron alloys, began to replace glass as the material of choice for forming frames for high performance applications, such as high speed CT scanners, while using glass or ceramic for the cathode and anode end portions to provide electrical insulation. These particular metals are of high purity to provide low outgassing characteristics suited to vacuum environments. They are also able to withstand the high temperatures (about 500° C.) found in x-ray tubes. While copper is an effective thermal conductor, it is a relatively soft metal, due to the low yield point of annealed copper. It has a tendency to creep (deform plastically) under high temperatures and loads. Copper frames thus tend to distort under the forces generated at high rotation speeds, such as those in which the x-ray tube is rotated around a patient examination region in about a second, or less. The distortion can lead to inaccuracies in maintaining the position of the focal spot on the anode target. The tendency of copper to creep also affects baking out, the procedure used to process and clean out the tube, by limiting the bake out temperature of the frame.

With gantry speeds rising to about 120 rpm and demands for speed rising still further for improved cardiac and other imaging, manufacturers have moved to stainless steel for forming the frame. Although mechanically strong, stainless steel frames are not as efficient at transferring heat from one part of the frame to another as are copper frames. Additionally, transfer of the heat to the cooling liquid is slower than for copper. Localized heating of the frame tends to occur due to lower rates of conduction of heat through the frame. As heat from the anode strikes the stainless steel frame, the temperature of the frame can get sufficiently high that cooling oil breaks down. This is particularly a problem around the x-ray tube window due to heating from the focal spot and secondary electrons. Carbon formed as a result of cooling oil breakdown contaminates the oil, which can lead to arcing. The power output of the x-ray tube is therefore limited by the capacity of the frame to transfer heat away from the x-ray tube.

The present invention provides a new and improved method and apparatus which overcome the above-referenced problems and others.

In accordance with one aspect of the present invention, an x-ray tube is provided. The x-ray tube includes a frame which encloses an evacuated chamber. An anode is disposed within the evacuated chamber. The frame includes a vessel which surrounds the anode. The vessel includes a liner formed from a thermally conductive material which at least partially defines the evacuated chamber. A framework supports the liner and is formed from a structural material. The framework defines at least one thermal window therein through which the liner is in thermal contact with both the evacuated chamber and a surrounding cooling fluid.

In accordance with another aspect of the invention, a method of transferring heat from an x-ray tube to a surrounding cooling fluid is provided. The method includes conducting heat from an evacuated chamber through a liner of the x-ray tube formed from a thermally conductive material. The liner is restrained against deformation with a structural framework.

In accordance with another aspect of the invention, an x-ray tube is provided. The x-ray tube includes a thermally conductive liner which spaces an evacuated chamber of the x-ray tube from a surrounding cooling fluid. A structural framework reinforces the liner. The liner and the framework are stacked one within the other to form a vessel which houses an anode.

One advantage of at least one embodiment of the present invention is the provision of an x-ray tube frame capable of withstanding the forces generated at high gantry speeds.

Another advantage of at least one embodiment of the present invention is that the frame is readily joined to other components of the x-ray tube.

Another advantage of at least one embodiment of the present invention is that it enables efficient cooling of an x-ray tube and avoids localized breakdown of cooling oil.

Another advantage of at least one embodiment of the present invention is that it enables the frame to be machined after brazing without providing special tooling to support the inside of the frame.

Another advantage of at least one embodiment of the present invention is that it enables the focal spot and anode to cathode spacing to remain stable under large external forces that occur during scanning.

Another advantage of at least one embodiment of the present invention resides in extended x-ray tube life.

Still further advantages of the present invention will become apparent to those of ordinary skill in the art. upon reading and understanding the following detailed description of the preferred embodiments.

The invention may take form in various components and arrangements of components, and in various steps and arrangements of steps. The drawings are only for purposes of illustrating a preferred embodiment and are not to be construed as limiting the invention.

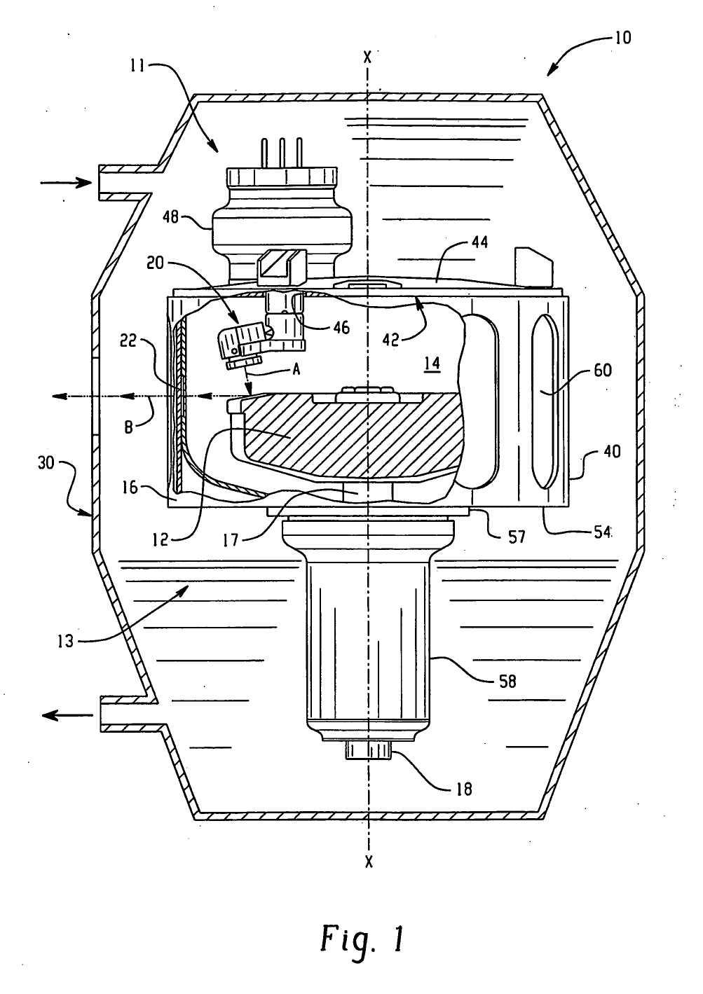

FIG. 1 is a perspective view of an x-ray tube assembly according to the present invention;

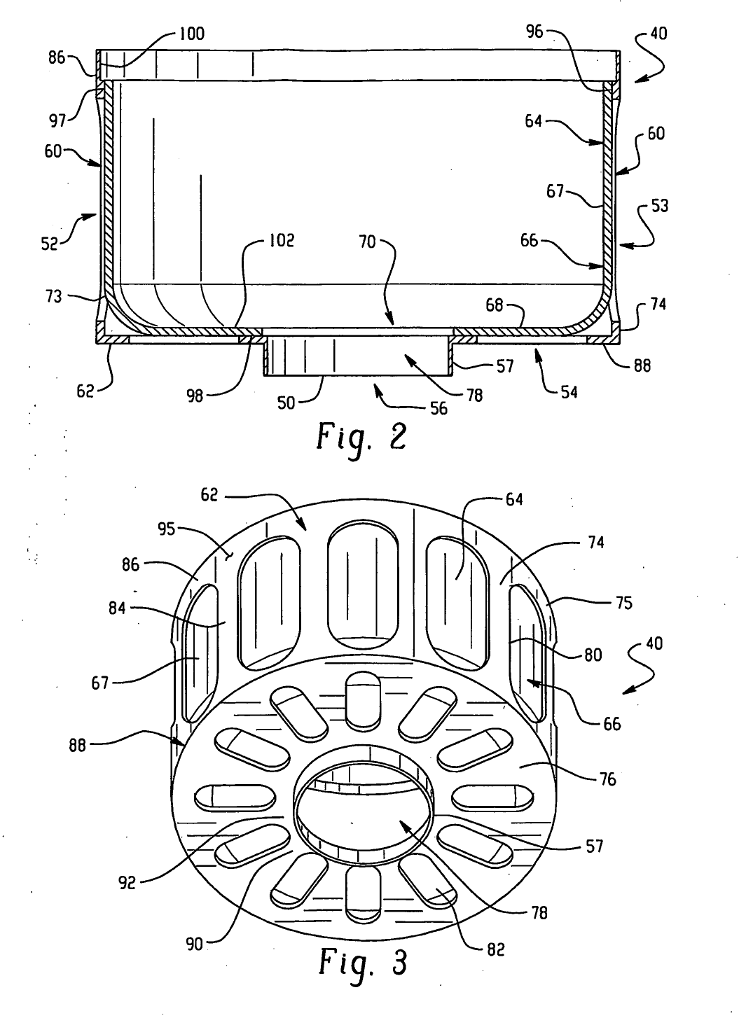

FIG. 2 is a side sectional view of a first embodiment of the x-ray tube vessel of FIG. 1;

FIG. 3 is a perspective view of the vessel of FIG. 2;

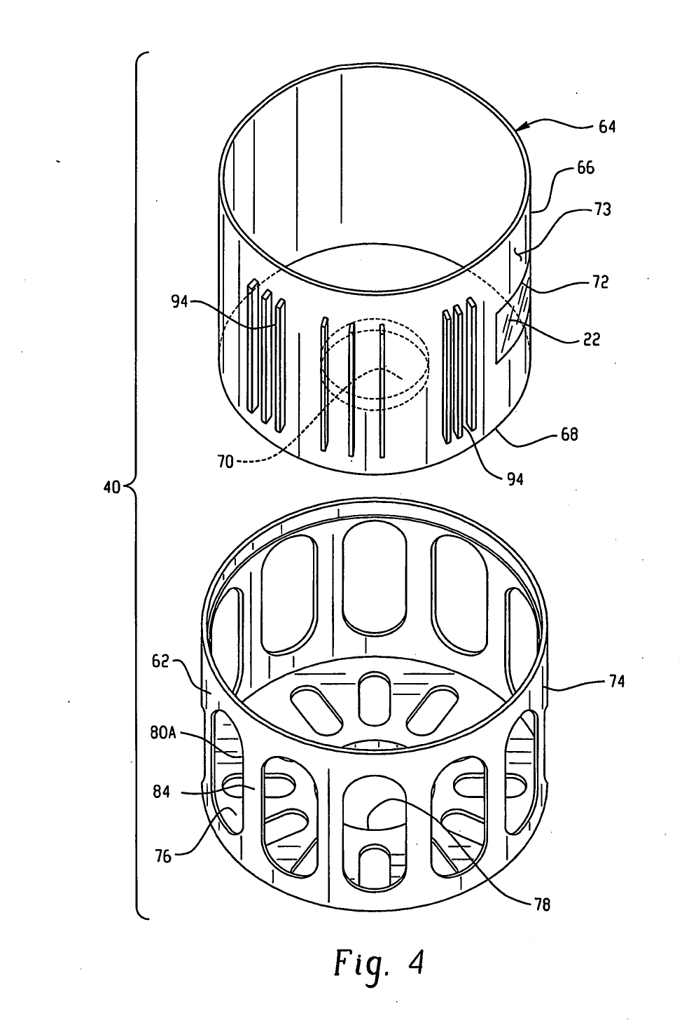

FIG. 4 is an exploded perspective view of the vessel of FIG. 2;

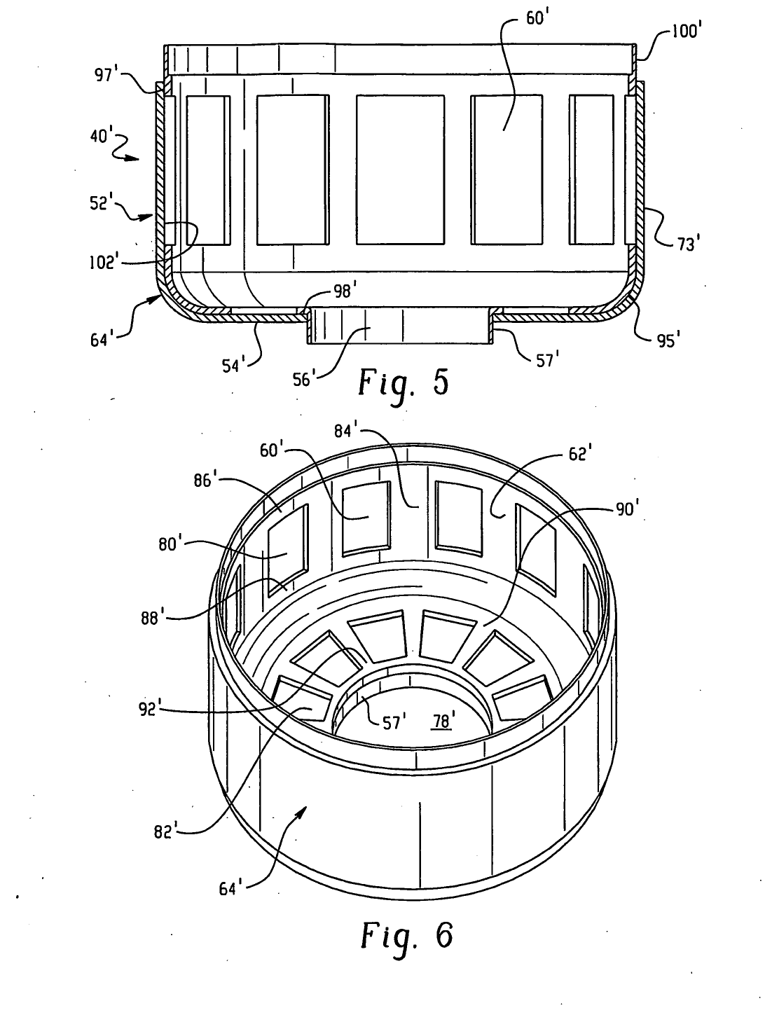

FIG. 5 is a is a side sectional view of a second embodiment of the x-ray tube vessel of FIG. 1;

FIG. 6 is a perspective view of the vessel of FIG. 5;

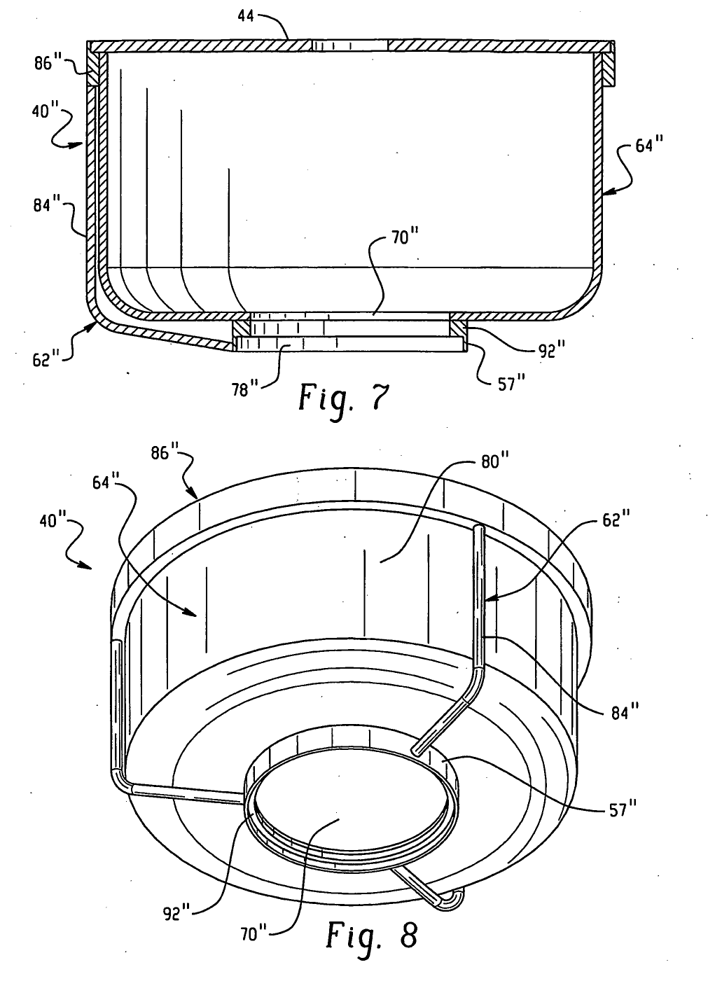

FIG. 7 is a side sectional view of a third embodiment of the x-ray tube vessel of FIG. 1;

FIG. 8 is a perspective view of the vessel of FIG. 7;

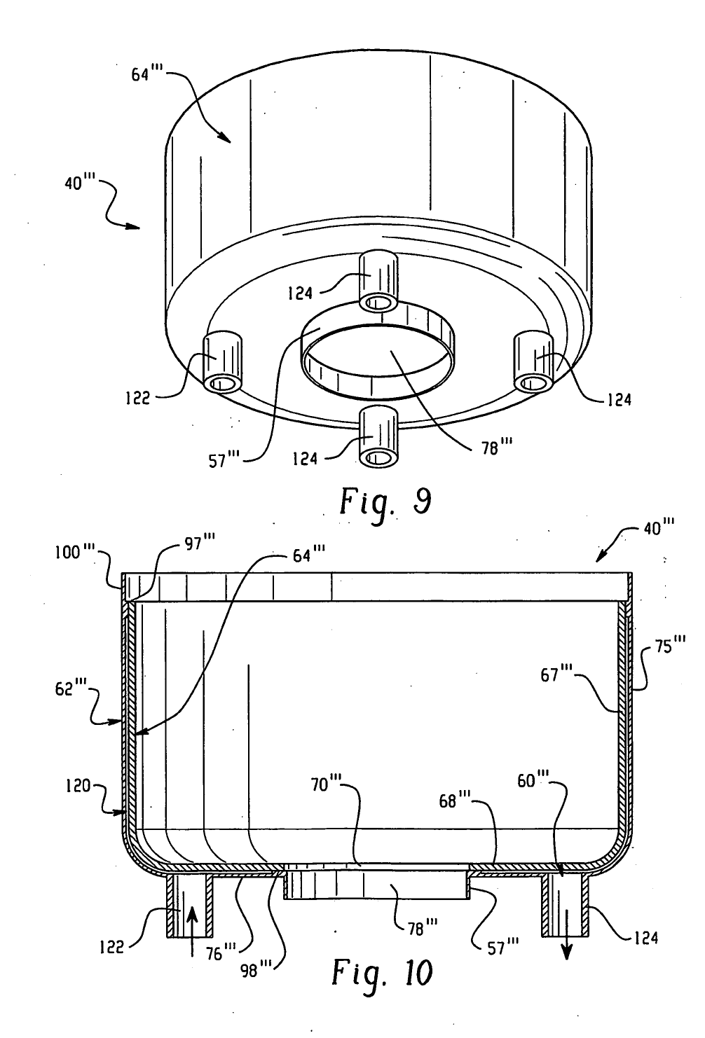

FIG. 9 is a perspective view of a fourth embodiment of the x-ray tube vessel of FIG. 1; and

FIG. 10 is a side sectional view of the vessel of FIG. 9.

With reference to FIG. 1, an x-ray tube assembly 10 of the type used in medical diagnostic systems, such as computed tomography (CT) scanners, for providing a beam of x-ray radiation is shown. The x-ray tube assembly 10 includes an x-ray tube 11 comprising an anode 12, which is rotatably mounted in an evacuated chamber 14. The chamber is defined by an envelope or frame 16, shown partially cut away in FIG. 1. The x-ray tube anode 12 is supported on a shaft 17 which is mounted for rotation about an axis X via a bearing assembly shown generally at 18. A heated element cathode 20 supplies and focuses electrons A. The cathode is biased, relative to the anode 12, such that the electrons are accelerated to the anode. A portion of the electrons striking a target area of the anode is converted to x-rays B, which are emitted from the x-ray tube through an x-ray permeable window 22 in the frame.

The x-ray tube assembly 10 also includes a housing 30, filled with a heat transfer and electrically insulating coolant 13, such as a dielectric oil. The housing 30 surrounds the frame 16 of the x-ray tube 11. The cooling liquid is directed to flow past the window 22, the frame 16, bearing assembly 18, and other heat-dissipating components of the x-ray tube assembly 10.

The frame 16 includes a bucket-shaped vessel 40 which defines the widest portion of the frame and surrounds the anode 12. The vessel 40 is in direct contact with the cooling oil 13. An upper end 42 of the vessel 40 is closed by an annular cathode plate 44. The cathode plate 44 has a central aperture 46 through which the cathode 20 extends. A housing or insulator 48 for the cathode is welded or otherwise attached to the cathode plate 44 around the aperture 46. The terms “upper” and “lower” and the like are used with reference to the orientation of the x-ray tube assembly illustrated in FIG. 1. It will be appreciated that the assembly, in operation, may have other orientations.

With reference also to FIG. 2, the vessel 40 diminishes in internal diameter toward a lower end 50 thereof. In the illustrated embodiment, the vessel includes a side wall 52 including a cylindrical upper portion 53, which is connected at its lower end with an annular base portion 54. The base portion 54 defines a central aperture 56 through which the anode shaft 17 extends. Around the aperture 56 is an annular weld flange 57. The vessel 40 is mounted by the weld flange 57 to a lower portion 58 of the frame which houses the bearing assembly. The lower portion 58 of the frame may be wholly or partially formed from glass or ceramic with metal flanges to electrically isolate the anode from the cathode.

With reference also to FIGS. 3 and 4, the vessel 40 is a composite of a thermally conductive material and a structural material. The thermally conductive material provides a plurality of thermally conductive pathways 60 through the vessel for transfer of heat from the anode 12 to the cooling liquid 13, while the structural material provides a structural framework or skeleton 62 which provides sufficient rigidity to the vessel to withstand the deformational forces caused by high gantry rotation speeds while providing thermal windows or cutouts for the cooling liquid to make thermal contact with the evacuated chamber, via the thermally conductive passages. The thermally conductive passages 60 are defined by a liner 64, supported by the framework 62.

The thermally conductive material is preferably one which has a thermal conductivity of at least 100 Watts/meter*degrees Kelvin, preferably, at least 200 W/m*K, and most preferably, at least 350 W/m*K. The thermally conductive material is preferably free or substantially free of materials which have a tendency to outgas in the low vacuum conditions of the x-ray tube. Suitable thermally conductive materials of this type include copper, copper-beryllium alloys, other copper alloys, and the like. For example, the thermally conductive material may be formed from copper, with copper being the primary element present. The thermally conductive material preferably comprises at least 90% copper, more preferably, at least 99% copper. At high purity, copper has a thermal conductivity of about 400 W/m*K. The thermal conductivity of copper-based materials tends to diminish as the proportion of alloying material or impurities increases. In contrast, stainless steels have a thermal conductivity of 10-25 W/m*K. In general, the thermal conductivity of the structural material is less than that of the thermally conductive material, generally, less than half the thermal conductivity of the thermally conductive material.

The structural material is preferably one which has a yield strength of at least about 1400 Kg/cm², more preferably, at least 2100 Kg/cm², as measured by ASTM D 882 or a similar test method. Exemplary structural materials include ferrous materials, particularly stainless steel. Other high strength materials suited for forming the framework include Inconel™ and other nickel alloys, titanium, Kovar™, and the like. Stainless steel has a yield strength of about 2800 to 3500 Kg/cm². Pure copper by comparison, has a yield strength of less than 700 Kg/cm². In general, the thermally conductive material may have a yield strength which is less than that of the structural material, generally less than half that of the structural material. The creep strength of the structural material is preferably high. Preferably, the structural material has a minimum creep strength of 350 Kg/cm², more preferably 700 Kg/cm² which is equivalent to 1% creep in 10,000 hours of service at 500° C.

In the embodiment of FIGS. 2 and 3, the vessel 40 includes an inner liner 64 formed of the thermally conductive material, which is carried within and contacts the framework 62. The liner 64 includes a side wall 66, which includes a generally cylindrical portion 67, connected at its lower end with an annular base portion 68. The base portion defines a central aperture 70 therein. As shown in FIG. 4, the window 22 of the x-ray tube 11 is set into a suitably shaped opening 72 in the cylindrical portion 67 of the liner side wall, and may be formed, for example, from beryllium, titanium, or the like. Mounting the window 22 to the liner 64 rather than to the framework 62 increases the conduction of heat away from the window, where overheating is often prone to occur, due to the deflection of electrons from the target area of the anode. For example, a shelf (not shown) is milled into an outer surface 73 of the liner side wall 66. The window 22 is then brazed, welded, or otherwise attached to the shelf.

Alternatively, the window 22 is mounted to the framework 62, with closely adjacent thermal passages 60 of copper to aid in heat removal. In this case the framework is hermetically sealed around the window to the liner, with a hole in the liner for the x-rays to pass through.

The framework 62 of the vessel is similarly shaped to the liner 64 and includes a side wall 74 with a cylindrical wall portion 75 and an annular base portion 76 from which the flange 57 depends. The base portion 76 defines a central aperture 78 concentric with the opening 70 in the liner and of similar size. The liner aperture 70 and framework aperture 78 together define the central aperture 56 of the vessel.

Slots 80, 82 are formed in the wall portion 75 and base portion 76, respectively, which serve as thermal windows to the liner 64 contained within the framework. The slots 80, 82 (twelve angularly spaced slots of each type are illustrated in FIG. 3) are sized to optimize thermal transfer from the vessel 40 while allowing the liner 64 to be substantially thinner than a comparable copper frame formed without a framework. While the illustrated slots 80, 82 are generally ovoid, other shapes and sizes of slots are contemplated. The thermally conductive pathways 60 are defined by portions of the underlying liner 64 which are exposed to the cooling liquid through the slots 80, 82. As illustrated in FIG. 4, at least one of the slots 80A is positioned over the window 22 so that x-rays leaving the frame 16 pass through the slot without interference by the framework.

With continued reference to FIG. 3, the framework 62 includes a plurality of ribs 84, intermediate each of the slots 80, which extend parallel with the axis of rotation X of the anode. The ribs 84 are connected, at upper and lower ends, to annular, ring-like portions 86, 88 of the framework. In the base portion 76, radially extending ribs 90, intermediate the slots 82, join the annular frame portion 86 with an inner annular frame portion 92, adjacent the aperture 78.

It will be appreciated that other configurations of a constraining framework are contemplated. In its simplest form, the framework serves as a cage and comprises an upper annular portion 86 and an inner annular frame portion 92, connected by ribs. Preferably there are a minimum of three ribs 84, 90, which are angularly spaced around the vessel 40. Ribs 90 may simply be extensions of ribs 84.

To improve heat flow from the liner 64, the exterior surface 73 of the liner, e.g., in the regions of the slots 80, 82, is provided with fins, projections, or other surface features 94 which increase the surface area of the liner that is exposed to the cooling oil. FIG. 4 illustrates a surface 73 with fins 94, by way of example. Although some heat flows to the cooling fluid through contact with an outer surface 95 of the framework, the bulk of the heat transfer from the vessel 40 occurs through the thermal passages 60 formed at the slots 80, 82.

The framework 62 is preferably attached to the liner 64, at least at selected points. In the embodiment of FIGS. 2 and 3, an inner surface 96 of the framework 62 is attached to the outer surface 73 of the liner. This attachment helps to minimize relative movement between the liner and the framework during heating and cooling of the x-ray tube 11 and under the forces generated by rotation of the x-ray tube about the patient. In one embodiment, the framework is brazed to the liner, either over the entire area of contact, or at select locations. For example, the framework 62 is optionally brazed to the liner to form hermetic seals at sealing regions 97, 98 adjacent the annular portions 86, 92 (FIG. 2). Other methods of attachment are also contemplated. For example, diffusion bonding or explosion bonding is used to bond the framework to the liner. In diffusion bonding, a high pressure is used to squeeze the two components together, preferably accompanied by a high temperature. In explosion bonding, an explosive charge is used to force the liner and framework into contact.

In another method of attachment, the framework 62 is formed first and the liner 64 is subsequently cast onto the framework (or vice versa). Optionally, the high thermal conductivity liner can encompass the structural framework. The cast liner can then be machined, as appropriate, without the need for an interior support structure to prevent deformation of the liner. In yet another method, suitably sized sheets of material for the liner and framework are prepared (optionally with the slots 80, 82 and apertures 70, 78 cut out). The two or more layers are pressed with a ram into a mold, forming the shape of the vessel under high pressure.

As shown in FIG. 2, the side wall 74 of the framework 62 extends slightly above the side wall 66 of the liner 64 to provide a weld flange 100 by which the vessel 40 is welded or otherwise rigidly attached to the plate 44.

In the embodiment of FIGS. 2-4, the framework 62 is entirely outside the liner 64 and thus is not generally exposed to the vacuum environment. Accordingly, the framework material, such as stainless steel, need not be free of impurities of the type which tend to outgas in the vacuum environment. However, where portions of the framework are exposed to the vacuum environment, the framework material is preferably selected to minimize impurities which tend to outgas. Stainless steels, Inconel™, nickel alloys, titanium, and Kovar™ are suitable vacuum compatible materials. Positioning the liner 64 in contact with the vacuum environment provides an inner surface 102 which absorbs heat relatively uniformly.

With reference now to FIGS. 5 and 6, where similar elements are numbered with a primed suffix (′), a vessel 40′ includes an outer liner 64′ formed of a conductive material, and a framework 62′, formed of a structural material. The framework and liner are similar to liner 64 and framework 62 of FIGS. 2-3, except in that the framework 62′ is located interior to the liner 64′ , with an outer surface 95′ of the framework attached to an inner surface 102′ of the liner. The entire outer surface 73′ of the liner, in this embodiment, is in direct contact with the coolant. Other features of the vessel 40′ can be otherwise similar to the embodiment of FIGS. 2-3. Since the stainless steel framework 62′ is exposed to the vacuum environment, the framework material is preferably free or substantially free of impurities which have a tendency to outgas in the vacuum environment. Portions of the liner 64′ are also directly exposed to the vacuum environment and these too are preferably free of outgassing impurities.

The combination of copper and stainless steel is particularly suitable for forming the liner 64, 64′ and framework 62, 62′, respectively. They have relatively similar thermal expansion coefficients. The coefficient for copper is about 20×10⁻⁶ cm/cm/° C., which is slightly higher (about 10% higher) than that of stainless steel. Where the copper liner 64 is interior to the steel framework 62, this difference in thermal expansion has little or no effect on the structural stability of the vessel, since the steel acts to prevent or substantially limit any expansion of the copper liner which exceeds that of the stainless steel. Even where the liner 64′ is placed exterior to the framework 62′, the welding or other form of attachment of the liner to the framework helps to offset any tendency of the copper to expand away from the steel.

Similarly, although copper begins to exhibit noticeable material creep at a load of about 70-210 Kg/cm², the comparable value for stainless steel is at least about 700 Kg/cm². The stainless steel framework thus provides a vessel 40, 40′ which is resistant to creep. Stainless steel also has a resistance to bending which is 30-40% higher than that of copper. As a result, the vessel has, in large part, the structural strength and rigidity of a steel vessel, while retaining, in large part, the thermal conductivity of a copper vessel.

In another embodiment (not shown), rather than having slots 80, 82, 80′, 82′ through which the thermal passageways in the liner make direct contact with the cooling liquid, thinned regions of the framework are provided of a similar shape and size to the slots, which serve as thermal windows. The thinned regions have a wall thickness which is less than half that of the ribs, preferably less than 30%. The thinned regions are thin enough that they do not appreciably limit the heat flow therethrough, but thick enough to provide a gas impermeable barrier.

In yet another embodiment (not illustrated), a framework similar to framework 62, 62′ is sandwiched between respective inner and outer liners similar to liners 64 and 64′.

With reference now to FIGS. 7 and 8, where similar elements are numbered with a double primed suffix (″), a vessel 40″ includes an inner liner 64″ formed of a conductive material, and a framework 62″ formed of a structural material. The framework and liner are similar to liner 64 and framework 62 of FIGS. 2-3, except as noted. In this embodiment, the framework 62″ is formed of round or tubular wire. Ribs 84″ in the form of spokes (three in the illustrated embodiment), are defined by pieces of the wire, which are brazed, welded or otherwise attached at ends thereof to annular portions or support rings 86″ 92″. It is appreciated that the ribs need not be round, and many other shapes are possible. The support rings, in turn, are brazed or welded to the liner 64″. The upper support ring 86″ is also brazed, welded or otherwise attached to the cathode plate 44. The lower support ring 92″ defines a flange 57″ which is attached to the lower portion 58 of the frame housing the bearing (FIG. 1). Spaces 80″ between the spokes and support rings 86″, 92″ define thermal windows through which the cooling oil makes thermal contact with the chamber, via the thermally conductive material. Optionally, additional subframework elements which are significantly more deformation resistant than the liner, but significantly more thermally conductive than the framework, can be used to supplement the framework.

With reference now to FIGS. 9 and 10, where similar elements are numbered with a triple primed suffix (′″) and new elements are given new numerals, a vessel 40′″ includes an inner liner 64′″ formed of a conductive material, and a framework 62′″, formed of a structural material. The framework and liner are similar to liner 64 and framework 62 of FIGS. 2-3, except as noted. The framework 62′″ is spaced from the liner 64′″, except at regions of attachment 97′″, 98′″, to provide an annular cooling passage 120 for cooling oil to pass between the framework and the liner. The oil may be directed through the cooling passages by walls (not shown) constructed between the liner and framework to optimize the cooling efficiency of the oil. The conductive liner may have projections at the points of attachment to maintain the oil gap width. Cooling fluid inlet and outlet ports 122, 124 are formed in the framework 62′″ through which cooling fluid from the x-ray tube housing is directed through the cooling passage. Optionally, the cooling fluid inlet port 122 is connected with a pump (not shown) which supplies pressurized cooling fluid to the passage 120.

In this embodiment, thermal windows are defined by the outlet ports 124, for thermal contact between the cooling oil and the chamber 14, via the liner. The entire volume of the liner can be considered as a thermal passage 60′″. While there are no slots analogous to slots 80, 82 in the embodiment illustrated, it is also contemplated that slots similar to slots 80, which are preferably spaced from the inlet port 122, may be provided in addition to, or in place of the outlet ports 124.

The invention has been described with reference to the preferred embodiment. Modifications and alterations will occur to others upon a reading and understanding of the preceding detailed description. It is intended that the invention be construed as including all such modifications and alterations insofar as they come within the scope of the appended claims or the equivalents thereof.

Having thus described the preferred embodiment, the invention is now claimed to be:

1. An x-ray tube (11) comprising:
a frame (16) which encloses an evacuated chamber (14);
an anode (12) disposed within the evacuated chamber;
the frame including a vessel (40, 40′, 40″, 40′″) which surrounds the anode, the vessel being defined by a combination of a material with high thermal conductivity and lower deformation resistance and a material with high deformation resistance and lower thermal conductivity.

2. The x-ray tube according to claim 1, wherein the vessel includes:
a liner (64, 64′, 64″, 64′″) formed from a thermally conductive material which at least partially defines the evacuated chamber; and
a framework (62, 62′, 62″, 62′″) which supports the liner and is formed from a structural material, the framework defining at least one thermal window (80, 80′, 80″, 82, 82′, 124) therein through which the liner is in thermal contact with both the evacuated chamber and a surrounding cooling fluid.

3. The x-ray tube according to claim 2, wherein the framework and the liner are concentric.

4. The x-ray tube according to claim 2, wherein the framework (62, 62″, 62′″) surrounds the liner (64, 64″, 64′″).

5. The x-ray tube according to claim 2, wherein the thermal window comprises at least one slot (80, 80′, 80″, 82, 82′) defined in the liner (64, 64′).

6. The x-ray tube according to claim 5, wherein the at least one slot includes a plurality of angularly spaced slots (80, 80′, 80″, 82, 82′).

7. The x-ray tube according to claim 2, wherein the thermally conductive material has a thermal conductivity which is at least twice that of the structural material.

8. The x-ray tube according to claim 2, wherein the structural material has a yield strength which is at least twice that of the thermally conductive material.

9. The x-ray tube according to claim 2, wherein the structural material includes stainless steel.

10. The x-ray tube according to claim 2, wherein the thermally conductive material includes copper.

11. The x-ray tube according to claim 2, wherein the liner includes a cylindrical side (67, 67′, 67′″), and a base (68, 68′, 68′′) and wherein the framework includes a cylindrical side (75, 75′, 75′″) and a base (76, 76′, 76′″), the side of the liner being joined to the side of the framework.

12. The x-ray tube according to claim 2, wherein one of the liner and the framework is received within the other of the liner and the framework.

13. The x-ray tube according to claim 2, wherein the liner defines a central aperture (70, 70′, 70″, 70′″) and the framework defines a central aperture (78, 78′, 78″, 78′″), the anode including a shaft (17) which extends through the central apertures.

14. The x-ray tube according to claim 2, wherein the liner and the framework define a fluid flowpath (120) there between for the cooling fluid to contact the liner.

15. The x-ray tube according to claim 2, further including a plate (44) which closes an end (42) of the vessel (40, 40′, 40″, 40′″), the plate defining an aperture (46) through which a cathode assembly extends for emitting electrons that pass between a cathode and the anode.

16. The x-ray tube according to claim 2, wherein the vessel comprises a laminate of the conductive and structural materials.

17. An x-ray tube assembly (10) comprising:
the x-ray tube(11) of claim 1; and
a housing (30) surrounding at least a portion of the x-ray tube, the housing containing the cooling fluid.

18. A method of transferring heat from an x-ray tube (11) to a surrounding cooling fluid comprising;
conducting heat from an evacuated chamber (14) through a liner (64, 64′, 64″, 64′″) of the x-ray tube formed from a thermally conductive material;
restraining the liner against deformation with a structural framework (62, 62′, 62″, 62′″).

19. The method according to claim 18, wherein the structural framework defines at least one thermal window (80, 80′, 80″, 82, 82′, 124), the heat flowing directly between the liner and the surrounding cooling fluid in the thermal window.

20. An x-ray tube (11) comprising:
a thermally conductive liner (64, 64′, 64″, 64′″) which spaces an evacuated chamber (14) of the x-ray tube from a surrounding cooling fluid;
a structural framework (62, 62′, 62″, 62′″) forming a cage which reinforces the liner against deformation.

21. The x-ray tube of claim 18 further including an anode (12) mounted in the evacuated chamber.
